(19) United States
(12) Patent Application Publication
(10) Pub. No.: US 2022/0349021 A1
(43) Pub. Date: Nov. 3, 2022

(54) HIGH STRENGTH THIN SPECIFICATION HIGH CORROSION RESISTANCE STEEL AND MANUFACTURING METHOD THEREFOR

(71) Applicant: BAOSHAN IRON & STEEL CO., LTD., Shanghai (CN)

(72) Inventor: Jianchun WU, Shanghai (CN)

(73) Assignee: BAOSHAN IRON & STEEL CO., LTD., Shanghai (CN)

(21) Appl. No.: 17/637,239

(22) PCT Filed: Sep. 15, 2020
(86) PCT No.: PCT/CN2020/115294

§ 371 Date: Feb. 22, 2022

(30) Foreign Application Priority Data
Sep. 19, 2019 (CN) 201910889380.1

(51) Int. Cl. C21D 9/52; C22C 38/58; C22C 38/54; C22C 38/48; C22C 38/46; C22C 38/42; C22C 38/06; C22C 38/00; C21D 8/02; C21D 6/00; C23C 2/40; B32B 15/01

(52) U.S. Cl. CPC C21D 9/52; C22C 38/58; C22C 38/54; C22C 38/48; C22C 38/46; C22C 38/42; C22C 38/06; C22C 38/008; C22C 38/002; C22C 38/001; C21D 8/0226; C21D 8/0263; C21D 8/0205; C21D 6/008; C21D 6/005; C21D 6/004; C23C 2/40; B32B 15/013

(57) ABSTRACT

Disclosed are a high strength thin specification high corrosion resistance steel and a manufacturing method therefor. The chemical ingredients of the steel in percentages by weight are as follows: 0.02-0.06% of C, 0.1-0.5% of Si, 0.4-1.7% of Mn, ≤0.02% of P, 4.0-6.0% of Cr, 1.0-3.0% of Ni, ≤0.007% of S, 0.004-0.010% of N, <0.001% of Als, 0.001-0.006% of B, 0.007-0.020% of total oxygen [O]_{T}, and the balance is Fe and inevitable impurities, and same simultaneously satisfy: comprising one or both elements of 0.01-0.08% of Nb or 0.01-0.08% of V; and Mn/S≥250. In the invention, micro-alloy elements such as Nb/V and a B element are selectively added to steel, the basicity of slag, the type and melting point of the inclusion in steel, the content of free oxygen in molten steel and the content of acid-soluble aluminum Als during the smelting process are controlled, and a strip is then cast by means of twin-roll thin strip continuous casting, and enters an online rolling mill for hot rolling in closed conditions, and after rolling, the strip steel is cooled by air atomization cooling.

### TECHNICAL FIELD

The present disclosure relates to corrosion-resistance steel and a manufacturing process therefor, in particular to a high-strength, thin-gauge, high-corrosion-resistance steel and a manufacturing method therefor.

### BACKGROUND ART

Traditional thin strip steel is mostly produced by multi-pass continuous rolling of a cast slab having a thickness of 70-200 mm. The traditional hot rolling process is: continuous casting+cast slab reheating and heat preservation+rough rolling+finish rolling+cooling+coiling. Particularly, a cast slab having a thickness of about 200 mm is firstly obtained by continuous casting; the cast slab is reheated and held; then, rough rolling and finish rolling are performed to obtain a steel strip having a thickness generally greater than 2 mm; and finally, laminar cooling and coiling are performed on the steel strip to complete the entire hot rolling production process. If a steel strip having a thickness of less than or equal to 1.5 mm is to be produced, it is relatively difficult, because subsequent cold rolling and annealing of the hot-rolled steel strip are generally necessary. In addition, the long process flow, the high energy consumption, the large number of unit devices, and the high capital construction cost result in high production cost.

The thin slab continuous casting and rolling process flow is: continuous casting+heat preservation and soaking of the cast slab+hot continuous rolling+cooling+coiling. The main differences between this process and the traditional process are as follows: the thickness of the cast slab in the thin slab process is greatly reduced to 50-90 mm Because the cast slab is thin, the cast slab only needs to undergo 1-2 passes of rough rolling (when the thickness of the cast slab is 70-90 mm), or does not need to undergo rough rolling (when the thickness of the slab is 50 mm). In contrast, the continuous casting slab in the traditional process needs to be rolled repeatedly for multiple passes before it can be thinned to the required gauge before finish rolling. In addition, the cast slab in the thin slab process does not undergo cooling, but enters a soaking furnace directly for soaking and heat preservation, or a small amount of heat is supplemented. Hence, the thin slab process greatly shortens the process flow, reduces energy consumption, reduces investment, and thus reduces production cost. However, due to the fast cooling rate, the thin slab continuous casting and rolling process increases the steel strength and yield ratio, thereby increasing the rolling load, so that the thickness gauge of the hot-rolled products that can be economically produced cannot be too thin, generally ≥1.5 mm See Chinese patents CN200610123458.1, CN200610035800.2 and CN200710031548.2.

The endless thin slab continuous casting and rolling process (ESP in short) rising in recent years is an improved process developed on the basis of the above semi-endless thin slab continuous casting and rolling process. The ESP realizes endless rolling for continuous casting of a slab, and eliminates the flame cutting of the slab and the heating furnace that is used for heat preservation, soaking and transition of slabs. The length of the entire production line is greatly shortened to about 190 meters. The slab produced by continuous casting with a continuous casting machine has a thickness of 90-110 mm and a width of 1100-1600 mm. The slab produced by continuous casting passes through an induction heating roll table to effect heat preservation and soaking on the slab. Then, the slab enters the rough rolling, finish rolling, laminar cooling, and coiling processes to obtain a hot-rolled plate. Since this process realizes endless rolling, a hot-rolled plate having a minimum thickness of 0.8 mm can be obtained, which expands the range of the gauge of hot-rolled plates. In addition, the output of a single production line can reach 2.2 million t/year. At present, this process has been developed and promoted rapidly, and there is a plurality of ESP production lines in operation around the world.

The thin strip continuous casting and rolling process has a shorter process flow than the thin slab continuous casting and rolling process. The thin strip continuous casting technology is a cutting-edge technology in the research field of metallurgy and materials. Its appearance brings about a revolution to the steel industry. It changes the production process of steel strip in the traditional metallurgical industry by integrating continuous casting, rolling, and even heat treatment, so that the thin strip blank produced can be formed into a thin steel strip at one time after one pass of online hot rolling. Thus, the production process is simplified greatly, the production cycle is shortened, and the length of the process line is only about 50 m. The equipment investment is also reduced accordingly, and the product cost is significantly reduced. It is a low-carbon, environmentally friendly process for producing a hot-rolled thin strip. The twin-roll thin strip continuous casting process is the main form of the thin strip continuous casting process, and it is also the only thin strip continuous casting process that has been industrialized in the world.

A typical process flow of twin-roll thin strip continuous casting is shown by FIG. 1. The molten steel in the ladle 1 passes through a ladle shroud 2, a tundish 3, a submerged nozzle 4 and a distributor 5, and is then directly poured into a molten pool 7 formed with side sealing plate devices 6a, 6b and two counter-rotating crystallization rolls 8a, 8b capable of rapid cooling. The molten steel solidifies on the circumferential surfaces of the rotating crystallization rolls 8a, 8b to form a solidified shell which gradually grows, and then forms a 1-5 mm thick strip 11 at the minimum gap (nip point) between the two crystallization rolls. The cast strip is guided by a guide plate 9 to pinch rolls 12 and sent to a rolling mill 13 to be rolled into a thin strip of 0.7-2.5 mm, and then cooled by a cooling device 14. After its head is cut off by a flying shear 16, it is finally sent to a coiler 19 to be coiled into a coil.

Thin-gauge high-corrosion-resistance steel is used more and more often in some fields that require high corrosion resistance, such as reconditioning of the compartments of green trains in the train manufacturing industry. The reconditioning of the compartments of green trains calls for a large share of the steel market, and imposes a stringent requirement on the corrosion resistance of the steel. Particularly, it requires that the corrosion resistance of the steel should be doubled on the basis of the traditional steel resistant to atmospheric corrosion. It also has a requirement for cost. In view of such a huge market demand, there is no ready-made steel that can be used directly, and a totally new type of steel must be developed. For cost consideration, stainless steel is not suitable. Considering that this product needs to have good bending and forming properties, the thickness gauge of the product is 1.0-2.0 mm. It's proposed in the present disclosure that the use of a thin strip continuous casting process to produce this high-strength and high-corrosion-resistance steel has certain advantages. Successful development of this thin-gauge, high-strength and high-corrosion-resistance steel product will provide a promising future to the train manufacturing industry in terms of weight reduction, greenization, energy reduction, high corrosion resistance (comparable to stainless steel), etc.

When thin strip continuous casting is employed to produce thin-gauge, high-strength and high-corrosion-resistance steel, due to the thin thickness, the thin strip continuous casting process has strong manufacturing and cost advantages. The characteristic thickness gauges of the high-strength and high-corrosion-resistance steel products supplied after post-treatment include 1.0 mm, 1.1 mm, 1.2 mm, 1.25 mm, 1.4 mm, 1.5 mm, 1.6 mm, 1.8 mm and 2.0 mm, etc. Due to the thin thicknesses of the products, it is difficult to produce them with the use of a traditional production line of continuous casting+hot continuous rolling. They are generally produced by a hot continuous rolling process followed by a cold rolling process. Such a production flow increases the cost for producing thin-gauge, high-strength and high-corrosion-resistance steel.

When hot-rolled strip steel is used as a thin-gauge hot-rolled plate or a hot-rolled product in place of a cold-rolled product, high surface quality of the strip steel is required. It is generally required that the thickness of the oxide scale on the surface of strip steel should be as thin as possible. This requires control of the formation of the oxide scale on the cast strip in the subsequent stages. For example, in a twin-roll continuous casting process for thin strip steel, a closed chamber device is used from the crystallization rolls to the inlet of the rolling mill to prevent oxidation of the cast strip. Addition of hydrogen to the closed chamber device as disclosed in U.S. Pat. No. 6,920,912 and control of the oxygen content to be less than 5% in the closed chamber device as disclosed in US Patent Application US20060182989 can both help to control the thickness of the oxide scale on the cast strip surface. However, there are few patents related to how to control the thickness of the oxide scale in the conveying process from the rolling mill to the coiler, especially in the process of cooling the strip steel by laminar cooling or spray cooling. When the high-temperature strip steel is in contact with the cooling water, the thickness of the oxide scale on the surface of the cast strip grows rapidly. At the same time, the contact of the high-temperature strip steel with the cooling water may also cause many problems: first, water spots (rust spots) may be formed on the surface of the strip steel, which will affect the surface quality; second, cooling water for laminar cooling or spray cooling tends to cause local uneven cooling on the surface of the strip steel, resulting in a nonuniform microstructure inside the strip steel, so that the properties of the strip steel are not uniform and the product quality is affected; third, the local uneven cooling on the surface of the strip steel may cause deterioration of the strip shape, which affects the shape quality.

However, because the thin strip continuous casting process itself is characterized by rapid solidification, the steel produced by this process generally has problems such as nonuniform structure, low elongation, high yield ratio and poor formability. At the same time, the austenite grains in the cast strip are obviously not uniform, such that the structure of the final product obtained after austenite transformation is not uniform, either. Hence, the properties of the product, especially formability, are not stable. Therefore, it's also somewhat difficult and challenging to produce high-strength and high-corrosion-resistance steel products with the use of a thin strip continuous casting production line. Breakthrough in both composition and process is necessary.

At present, a number of patent applications have been filed at home and abroad for corrosion-resistant steel and manufacturing methods therefor. In these applications, the composite micro-alloying technology with the use of Nb, V, Ti and/or Mo is mostly used for the corrosion-resistant steel of a strength grade of at least 450 MPa, wherein fine-grain strengthening and precipitation strengthening are used to improve the comprehensive mechanical properties of corrosion-resistant steel. The specific compositions and properties in the patent applications are shown in Table 1.

TABLE 1
Comparison of Corrosion-resistant Steel in the Patent Applications (wt %)

| Chemical | | | | | | | |
|---|---|---|---|---|---|---|---|
| components | CN2005101 | CN2006100 | CN201010 | CN200910 | CN200910 | CN20061 | U.S. Pat. No. |
| (wt %) | 11858.6 | 30713.8 | 246778.2 | 301054.0 | 180490.7 | 0125125.2 | 6,315,946 |
| C | 0.05-0.1 | 0.05-0.1 | 0.05-0.1 | ≤0.12 | 0.03-0.08 | 0.01-0.07 | 0.015-0.035 |
| Si | ≤0.75 | ≤0.5 | ≤0.15 | ≤0.75 | 0.3-0.6 | 0.25-0.5 | ≤0.4 |
| Mn | 1.0-1.6 | 0.8-1.6 | 1.5-2 | ≤1.5 | 1.3-1.8 | 1.6-2 | ≤2.0 |
| P | ≤0.02 | ≤0.02 | ≤0.015 | ≤0.025 | ≤0.015 | ≤0.018 | ≤0.012 |
| S | ≤0.01 | ≤0.01 | ≤0.01 | ≤0.008 | ≤0.01 | ≤0.008 | ≤0.005 |
| Al | 0.01-0.05 | 0.01-0.05 | — | — | ≤0.04 | ≤0.035 | ≤0.03 |
| Cr | 0.2-0.45 | 0.4-0.8 | 0.3-0.8 | 0.3-1.25 | 0.4-0.8 | 0.4-0.75 | 0.40-0.70 |
| Ni | 0.12-0.4 | 0.12-0.4 | 0.15-0.4 | 0.12-0.65 | 0.2-0.5 | 0.25-0.6 | 0.20-0.50 |
| Cu | 0.2-0.55 | 0.2-0.55 | 0.2-0.4 | 0.2-0.55 | 0.3-0.6 | 0.2-0.5 | 0.20-0.40 |
| Nb | ≤0.07 | ≤0.07 | 0.02-0.08 | 0.015-0.03 | 0.03-0.08 | 0.03-0.08 | 0.03-0.06 |
| Ti | ≤0.025 | ≤0.025 | 0.09-0.15 | 0.006-0.02 | ≤0.04 | ≤0.02 | 0.02-0.05 |
| V | | — | — | 0.09-0.15 | — | — | ≤0.10 |
| Mo | ≤0.35 | ≤0.35 | — | — | 0.1-0.4 | 0.1-0.4 | ≤0.50 |
| B | | — | — | — | — | 0.0005-0.003 | 0.0015-0.003 |
| Ca | 0.001-0.006 | 0.001-0.006 | — | — | ≤0.005 | — | — |
| N | 0.001-0.006 | 0.001-0.006 | ≤0.005 | 0.01-0.02 | — | — | ≤0.006 |
| Yield | ≥550 | ≥700 | ≥700 | ≥550 | ≥600 | ≥700 | ≥450 |
| strength, | | | | | | | |
| MPa | | | | | | | |
| Tensile | ≥600 | ≥750 | ≥800 | ≥650 | ≥760 | ≥750 | — |
| strength, | | | | | | | |
| MPa | | | | | | | |
| Elongation, % | ≥18 | ≥15 | ≥18 | ≥18 | ≥20 | ≥10 | — |

A micro-alloying scheme is used for the high-strength, corrosion-resistant steel in all the above patent applications, wherein alloy elements such as Nb, V, Ti, Mo, and/or the like are included in all the composition systems. In addition, the traditional hot rolling process is used for the production. The traditional hot rolling process is: continuous casting+cast slab reheating and heat preservation+rough rolling+finish rolling+cooling+coiling. Particularly, a cast slab having a thickness of about 200 mm is firstly obtained by continuous casting; the cast slab is reheated and held; then, rough rolling and finish rolling are performed to obtain a steel strip having a thickness generally greater than 2 mm; and finally, laminar cooling and coiling are performed on the steel strip to complete the entire hot rolling production process. If a steel strip having a thickness of less than 2 mm is to be produced, it is generally necessary to continue cold rolling and subsequent annealing of the hot-rolled steel strip. Addition of boron (B) element to steel is also mentioned in the above patent applications, such as Chinese Patent Application CN200610125125.2 and US Patent U.S. Pat. No. 6,315,946. However, the disclosed contents of the inventions do not reveal any specific method for process control after the boron (B) element is added, and the amount of the element added is also small.

The main problems with the use of the traditional process to produce micro-alloyed high-strength and corrosion-resistant steel include:

(1) The long process flow, the high energy consumption, the large number of unit devices, and the high capital construction cost result in high production cost.

(2) Corrosion-resistant steel contains a high level of copper and/or other prone-to-segregation elements for improving the corrosion resistance of a steel strip. The traditional process is likely to cause macrosegregation of copper and other elements due to the slow solidification cooling rate of the cast slab, resulting in the anisotropy of the cast slab, the occurrence of macrocracks, and the low yield.

(3) Corrosion-resistant steel is characterized by easy segregation in the traditional process. Therefore, in the composition design for high-strength and corrosion-resistant steel to be produced by the traditional process, copper is added in an amount of 0.2-0.55%. In actual production, the lower limit is usually employed. Chromium is added in an amount of 0.2-1.25, which is generally low. As a result, the corrosion resistance of the steel strip is not high.

(4) The corrosion resistance of this corrosion-resistant steel cannot meet the corrosion-resistant performance requirement of the steel according to the present disclosure. The present disclosure requires that the corrosion resistance should be doubled on the basis of the traditional corrosion-resistant steel.

(5) In the traditional process, since the micro-alloy elements cannot remain as solid solutions during the hot rolling process, they segregate partially, resulting in fine grains in the steel structure, an increased yield ratio and poor formability. This will significantly increase the rolling load, energy consumption, roll consumption, and damage to the equipment. As a result, the thickness range of the hot-rolled products of the high-strength and corrosion-resistant steel that can be economically and practically produced is limited, generally ≤2 mm. If the traditional hot-rolled product is further cold rolled, the thickness of the steel strip can be further reduced, but the high strength of the hot-rolled steel strip makes cold rolling difficult too. First, the high cold rolling load has higher requirements for equipment, and the damage to the equipment is large. Second, the second phase formed by precipitation of alloy elements in the hot-rolled product significantly increases the recrystallization annealing temperature of the steel strip after cold rolling.

If the thin slab continuous casting and rolling process is used to produce micro-alloyed high-strength and corrosion-resistant steel, the shortcomings of the traditional process can be overcome to a certain extent. The thin slab continuous casting and rolling process flow is: continuous casting+heat preservation and soaking of the cast slab+hot continuous rolling+cooling+coiling. The main differences between this process and the traditional process are as follows: the thickness of the cast slab in the thin slab process is greatly reduced to 50-90 mm Because the cast slab is thin, the cast slab only needs to undergo 1-2 passes of rough rolling (when the thickness of the cast slab is 70-90 mm), or does not need to undergo rough rolling (when the thickness of the slab is 50 mm). In contrast, the continuous casting slab in the traditional process needs to be rolled repeatedly for multiple passes before it can be thinned to the required gauge before finish rolling. In addition, the cast slab in the thin slab process does not undergo cooling, but enters a soaking furnace directly for soaking and heat preservation, or a small amount of heat is supplemented. Hence, the thin slab process greatly shortens the process flow, reduces energy consumption, reduces investment, and thus reduces production cost. In addition, the solidification cooling rate of the cast slab is accelerated in the thin slab process. This can reduce the macro-segregation of elements to a certain extent, thereby reducing product defects and improving the yield. Just for this reason, the content ranges of phosphorus and copper elements that improve corrosion resistance are broadened in the composition design for the micro-alloyed high-strength and corrosion-resistant steel to be produced by the thin slab process. This is beneficial for improving the corrosion resistance of steel.

Chinese Patent Application CN200610123458.1 discloses a method of producing 700 MPa grade high-strength and corrosion-resistant steel using a Ti micro-alloying process based on a thin slab continuous casting and rolling process flow. The chemical composition of the corrosion-resistant steel plate manufactured by this method comprises: C: 0.03-0.07%, Si: 0.3-0.5%, Mn: 1.2-1.5, P: ≤0.04%, S≤0.008%, Al: 0.025-0.05%, Cr: 0.3-0.7%, Ni: 0.15-0.35%, Cu: 0.2-0.5%, Ti: 0.08-0.14%, N: ≤0.008%, and a balance of Fe and unavoidable impurities. The steel plate has a yield strength of ≥700 MPa, a tensile strength of ≥775 MPa, and an elongation of ≥21%. In this patent application, phosphorus is controlled as an impurity element, and the content is ≤0.04% which is enlarged as compared with ≤0.025% in the traditional process.

Chinese Patent Application CN200610035800.2 discloses a method of producing 700 MPa grade V-N micro-alloyed corrosion-resistant steel based on a thin slab continuous casting and rolling process. The chemical composition of the corrosion-resistant steel plate manufactured by this method comprises: C: ≤0.08%, Si: 0.25-0.75%, Mn: 0.8-2, P: ≤0.07-0.15%, S: ≤0.04%, Cr: 0.3-1.25%, Ni: ≤0.65%, Cu: 0.25-0.6%, V: 0.05-0.2%, N: 0.015-0.03%, and a balance of Fe and unavoidable impurities. The steel plate has a yield strength of ≥700 MPa, a tensile strength of ≥785 MPa, and an elongation of ≥21%. In this patent application, phosphorus is controlled as an element that improves corrosion resistance, and the content is 0.07-0.15%. The content of copper is 0.25-0.6%, wherein its lower limit and upper limit are higher than the lower limit of 0.2% and the upper limit of 0.55% of the copper content respectively in the traditional process.

Although the thin slab process has the above advantages in the production of micro-alloyed high-strength and corrosion-resistant steel, some problems existing in the production employing the traditional process still exist in the thin slab process. For example, the micro-alloy elements cannot remain as solid solutions in the hot rolling process, either. Instead, partial segregation occurs, leading to an increase in the strength of the steel, thereby increasing the rolling load, energy consumption and roll consumption. Thus, the thickness gauge of the hot-rolled products of high-strength and corrosion-resistant steel produced economically and practically cannot be too thin. The thickness is ≥1.5 mm. See Chinese Patent Applications CN200610123458.1, CN200610035800.2 and CN200710031548.2.

Chinese Patent Application CN1633509A mentions a method of producing a copper-containing carbon steel product by thin strip continuous casting. This patent application emphasizes that this strip steel should be subjected to heat treatments such as annealing, tempering and the like in the temperature range of 400-700° C. to allow for precipitation or recrystallization of copper element in the strip steel. In contrast to this invention, trace elements B and Cr are added to the composition according to the present disclosure in obviously increased amounts, which constitutes an obvious distinguishing feature. In addition, the subsequent treatment process is completely different.

The method of manufacturing a high-copper, low-alloy thin strip mentioned in US Patent Application US2008264525/CN200580009354.1 is characterized in that the strip steel is cooled to below 1080° C. in a non-oxidizing atmosphere before entering a rolling mill in order to prevent the “hot shortness” phenomenon of the strip steel. In contrast to the present disclosure, trace element B is added in the above patent application, and the content of Cr is obviously increased. In addition, the subsequent treatment method after the strip is formed from the strip steel is also different.

International Patent Applications WO 2008137898, WO 2008137899, WO 2008137900, and Chinese Patent Applications CN200880023157.9, CN200880023167.2, CN200880023586.6 disclose a method of producing a micro-alloyed thin steel strip having a thickness of 0.3-3 mm by using a thin strip continuous casting and rolling process. The chemical composition used in this method is C: ≤0.25%, Mn: 0.20-2.0%, Si: 0.05-0.50%, Al: ≤0.01%, and also at least one of Nb: 0.01-0.20%, V: 0.01-0.20%, Mo: 0.05-0.50%. Under the conditions of hot rolling reduction ratio of 20-40% and coiling temperature of ≤700° C., the microstructure of the hot-rolled strip is bainite+acicular ferrite. According to the above patent applications, the alloy elements mainly existing in a solid solution state in the cast strip inhibit recrystallization of austenite after hot rolling. Even if the reduction rate reaches 40%, the recrystallization of austenite is also very limited. Since the hot rolling reduction rate of 20-40% does not cause recrystallization of austenite, the hardenability of coarse austenite remains after hot rolling, so that the structure of bainite+acicular ferrite is obtained at room temperature. No temperature range used for hot rolling is disclosed by the above patent applications. Nevertheless, an article (C.R. Killmore, etc. Development of Ultra-Thin Cast Strip Products by the CASTRIP® Process. AIS Tech, Indianapolis, Ind., USA, May 7-10, 2007) related to these patent applications reports that the temperature used for hot rolling is 950° C.

The thin strip continuously cast low carbon micro-alloyed steel products produced by this method have high strength. Within the above composition system, the yield strength can reach 650 MPa, and the tensile strength can reach 750 MPa, but the main problem is that the elongation of the product is not high (≤6% or ≤10%). The main reason for the low elongation is that the grain size of austenite in the cast strip obtained by the thin strip continuous casting process is not uniform, ranging from tens of microns to seven or eight hundred microns. The thin strip continuous casting process is generally followed by only 1-2 rolling mills, and the hot rolling reduction rate is usually difficult to exceed 50%. Hence, deformation has little effect in refining grains. If austenite grains are not refined by recrystallization, the nonuniform austenite structure is difficult to be effectively improved after hot rolling, and the bainite+acicular ferrite structure produced by transformation of unevenly sized austenite is also very uneven, so the elongation is not high.

In order to improve the strength-plasticity matching of thin strip continuously cast micro-alloyed steel, Chinese Patent Application 02825466.X proposes another method of producing a micro-alloyed steel strip having a thickness of 1-6 mm using the thin strip continuous casting and rolling process. The micro-alloyed steel composition system used in this method comprises C: 0.02-0.20%, Mn: 0.1-1.6%, Si: 0.02-2.0%, Al: ≤0.05%, S: ≤0.03%, P: ≤0.1%, Cr: 0.01-1.5%, Ni: 0.01-0.5%, Mo: ≤0.5%, N: 0.003-0.012%, and a balance of Fe and unavoidable impurities. The hot rolling of the cast strip is performed in the range of 1150-(Ar1-100) ° C., corresponding to hot rolling in the austenite region, the austenitic-ferrite two-phase region, or the ferrite region. The hot rolling reduction rate is 15-80%. In this method, an on-line heating system is designed to be positioned after the thin strip continuous casting and rolling unit, and the heating temperature range is 670-1150° C. The purpose is that, after the steel strip is hot rolled in different phase regions, the temperature of the steel strip can be held for a period of time to allow for complete recrystallization, so that the steel strip can obtain better matched strength and plasticity. When this method is used for production, it is necessary to add an on-line heating system in the design of the production line. Because the length of the heating time depends on the strip speed and the length of the heating furnace, the heating furnace must be long enough to ensure heating uniformity. This not only increases the investment cost, but also significantly increases the footprint of the thin strip casting and rolling line, reducing the advantages of the line.

### SUMMARY

One object of the present disclosure is to provide a high-strength, thin-gauge, high-corrosion-resistance steel and a manufacturing method therefor, wherein a thin strip continuous casting process is used to further reduce the production process cost and improve the product properties, especially the corrosion-resistant property of the product. The high-corrosion-resistance steel has a yield strength of at least 480 MPa, a tensile strength of at least 600 MPa, an elongation of at least 22%, and relative corrosion rate of ≤25%.

To achieve the above object, the technical solution of the present disclosure is as follows:

According to the present disclosure, B element and micro-alloy elements such as Nb/V and the like are selectively added to the steel. In the smelting process, the basicity of the slag, the type and melting point of the inclusions in the steel, the free oxygen content in the molten steel, and the content of acid-soluble aluminum Als are controlled. Then, twin-roll thin strip continuous casting is performed to cast a strip steel having a thickness of 1.5-3 mm. After the strip steel exits the crystallization rolls, it directly enters a lower closed chamber having a non-oxidizing atmosphere, and enters an on-line rolling mill for hot rolling under closed conditions. The rolled strip steel is cooled by gas atomization cooling. The gas atomization cooling can effectively reduce the thickness of the oxide scale on the surface of the strip steel, increase the temperature uniformity of the strip steel, and improve the surface quality of the strip steel. Finally, the steel coil produced may be used after pickling-flattening, or after pickling-hot-dip galvanization.

Particularly, the high-strength, thin-gauge and high-corrosion-resistance steel according to the present disclosure comprises the following chemical elements in weight percentages: C: 0.02-0.06%, Si: 0.1-0.5%, Mn: 0.4-1.7%, P≤0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, the following conditions are satisfied:

It comprises one or both of Nb: 0.01-0.08% or V: 0.01-0.08%; and/or one or both of Cu: 0.1-0.6% and Sn: 0.005-0.05%; and

Mn/S≥250.

In some embodiments, the high-strength, thin-gauge and high-corrosion-resistance steel according to the present disclosure comprises the following chemical elements in weight percentages: C: 0.02-0.06%, Si: 0.1-0.5%, Mn: 0.4-1.7%, P≤0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, the following conditions are satisfied: it comprises one or both of Nb: 0.01-0.08% and V: 0.01-0.08%; and Mn/S≥250.

In some embodiments, the high-strength, thin-gauge and high-corrosion-resistance steel according to the present disclosure comprises the following chemical elements in weight percentages: C: 0.02-0.06%, Si: 0.1-0.5%, Mn: 0.4-1.7%, P≤0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, the following conditions are satisfied: it comprises one or both of Nb: 0.01-0.08% and V: 0.01-0.08% and one or both of Cu: 0.1-0.6% and Sn: 0.005-0.05%; and Mn/S≥250.

The high-strength, thin-gauge, and high-corrosion-resistance steel according to the present disclosure has a microstructure of bainite or acicular ferrite, or a mixed microstructure of bainite+acicular ferrite.

The high-strength, thin-gauge, and high-corrosion-resistance steel according to the present disclosure has a yield strength of ≥480 MPa, a tensile strength of ≥600 MPa, an elongation of ≥22%, and a relative corrosion rate of ≤25%.

In some embodiments, the high-strength, thin-gauge, and high-corrosion-resistance steel according to the present disclosure has a thickness of 0.8-2.5 mm, preferably a thickness of 1.0-1.8 mm.

In some embodiments, the high-strength, thin-gauge, and high-corrosion-resistance steel according to the present disclosure has an average corrosion rate of <0.1250 mg/cm²·h.

In some embodiments, the high-strength, thin-gauge, and high-corrosion-resistance steel according to the present disclosure has a yield ratio of less than 0.8.

In some embodiments, the high-strength, thin-gauge, and high-corrosion-resistance steel according to the present disclosure has a yield strength of ≥480 MPa, a tensile strength of ≥620 MPa, an elongation of ≥22%, and a relative corrosion rate of ≤25%.

Preferably, Mn/S>250.

In the chemical composition design of the high-strength and high-corrosion-resistance steel according to the present disclosure:

C: C is the most economical and basic strengthening element in the steel. It increases the steel strength by solid solution strengthening and precipitation strengthening. C is an essential element for precipitation of cementite during austenite transformation. Hence, the level of C content largely determines the strength level of the steel. That is, a higher C content leads to a higher strength level. However, since the interstitial solid solution and precipitation of C do great harm to the plasticity and toughness of the steel, and an unduly high C content is unfavorable to the welding performance, the C content cannot be too high. The steel strength is compensated by appropriate addition of an alloy element(s). At the same time, for conventional slab continuous casting, casting in the peritectic reaction zone is prone to produce cracks in the surface of the cast slab, and breakout accidents may occur in severe cases. The same is true for thin strip continuous casting, i.e. casting in the peritectic reaction zone is prone to produce cracks in the surface of the cast strip blank, and the strip will be broken in severe cases. Therefore, the thin strip continuous casting of Fe—C alloy also needs to circumvent the peritectic reaction zone. Hence, the content of C used according to the present disclosure is in the range of 0.02-0.06%.

Si: Si plays a role in solid solution strengthening in the steel, and the addition of Si to the steel can improve steel purity and fulfill deoxygenation. However, an unduly high content of Si will deteriorate weldability and toughness of the welding heat affected zone. Hence, the content of Si used according to the present disclosure is in the range of 0.1-0.5%.

Mn: Mn is one of the cheapest alloy elements. It can improve the hardenability of the steel. It has a considerable solid solubility in the steel, and increases the steel strength by solid solution strengthening with no damage to the plasticity or toughness of the steel. It is the most important strengthening element to improve the steel strength, and it can also play a role in deoxygenation in the steel. However, an unduly high content of Mn will deteriorate weldability and toughness of the welding heat affected zone. Hence, the content of Mn used according to the present disclosure is in the range of 0.4-1.7%.

P: If the content of P is high, it is prone to segregate at the grain boundary, so that the cold brittleness of the steel will be increased, thereby worsening the weldability, and the plasticity of the steel will be decreased, thereby worsening the cold bendability. In the thin strip continuous casting process, the solidification and cooling rate of the cast strip is extremely fast, and thus the segregation of P can be suppressed effectively. As a result, the disadvantages of P can be avoided effectively, and full use of the advantages of P can be made. Therefore, according to the present disclosure, the P content is higher than that used in the traditional production process, and the limitation to the content of P element is relaxed appropriately. The dephosphorization process is eliminated from the steelmaking process. In the practical operation, it's not necessary to perform the dephosphorization process or add phosphorus intentionally, and the content of P is in the range ≤0.02%.

S: Generally, S is a harmful element in the steel. Particularly, it introduces hot shortness to the steel, reduces the ductility and toughness of the steel, and causes cracks during rolling. S also reduces weldability and corrosion resistance. Therefore, according to the present disclosure, S is also controlled as an impurity element, and its content is in the range of ≤0.007%. In some embodiments, the S content is ≤0.0067%. In addition, Mn/S≥250. In some embodiments, Mn/S>250.

Als: In order to curb the inclusions in the steel, Al cannot be used for deoxygenation as required by the present disclosure. In the use of refractories, additional introduction of Al should also be avoided as far as possible, and the content of acid-soluble aluminum Als should be strictly controlled: <0.001%.

N: Similar to C element, N element can improve the steel strength by interstitial solid solution. In the present disclosure, a certain amount of N needs to exist in the steel because the interaction of N and B is necessary in the steel to generate a precipitation phase of BN. However, the interstitial solid solution of N harms the plasticity and toughness of the steel to a relatively large extent, and the existence of free N may increase the yield ratio of the steel. Hence, the N content should not be too high. The content of N used according to the present disclosure is in the range of 0.004-0.010%.

Cr: Cr is not only an element that improves the hardenability of steel, but also the main alloy element in stainless steel. It can improve the corrosion resistance of the steel significantly. If its content is too high, the weldability will be deteriorated seriously. According to the present disclosure, the content of Cr is limited to 4.0-6.0%.

Ni: Ni can increase hardenability, and improve the low temperature toughness of steel significantly. It is a favorable element for improving the corrosion resistance and obdurability of the steel. At the same time, Ni can counteract the adverse influence of Cr on weldability, and Ni can also prevent the hot shortness of Cu effectively. According to the present disclosure, the content of Ni is limited to 1.0-3.0%.

Nb: In the thin strip continuous casting process, due to its unique characteristics of rapid solidification and rapid cooling, the alloy element Nb that is added may exist mainly in a solid solution state in the steel strip. Even if the steel strip is cooled to room temperature, precipitation of Nb can hardly be observed. Nb element which is solid dissolved in the steel can play a role in solid solution strengthening. The Nb content designed according to the present disclosure is in the range of 0.01-0.08%.

V: In the thin strip continuous casting process, V is similar to Nb, but its effect is weaker than that of Nb, and it also exists mainly in a solid solution state in the steel strip. Even if the steel strip is cooled to room temperature, precipitation of V can hardly be observed. V element which is solid dissolved in the steel can play a role in solid solution strengthening. The content of V used according to the present disclosure is in the range of 0.01-0.08%.

B: The notable role of B in the steel is that a minute amount of boron can multiply the hardenability of the steel. B may allow for preferential precipitation of coarse BN particles in high-temperature austenite, thereby inhibiting precipitation of fine AlN, weakening the pinning effect of the fine AlN on grain boundaries, and promoting the growth ability of grains. Hence, austenite grains are coarsened and homogenized. This is beneficial to recrystallization after rolling. The coarsening and homogenization of austenite grains further helps to improve the yield ratio of the product and improve the formability of the product. In addition, the combination of B and N can effectively prevent appearance of the low melting point phase B₂O₃ at the grain boundary.

B is an active element that is prone to segregation, and it tends to segregate at the grain boundary. When B-containing steel is produced by the traditional process, the B content is generally controlled very strictly, usually around 0.001-0.003%. In the thin strip continuous casting process, the solidification and cooling rate is fast. Hence, the segregation of B can be inhibited effectively, and more B can be solid dissolved. Therefore, the limitation to the B content can be relaxed appropriately. Coarse BN particles can also be produced by controlling the process appropriately to inhibit precipitation of fine AlN. In this way, B plays a role in nitrogen fixation. As shown by other studies, when B is added in combination with Nb and V, better effects can be achieved. Particularly, the possibility of segregation of C atoms may be decreased, and the precipitation of Fe₂₃(C,B)₆ at the grain boundary may be avoided. Hence, it is possible to add more B. Therefore, according to the present disclosure, a higher B content is used than the traditional process, and the range is 0.001-0.006%.

Cu: Cu in the steel mainly plays a role in solid solution strengthening and precipitation strengthening. At the same time, in the corrosion process of urban industrial atmosphere and sulfuric acid, Cu may be mainly enriched in the rust layer close to the uncorroded surface of the steel. During the corrosion process of industrial atmosphere and sulfuric acid, a protective film of Cu₂S may be formed to block reaction between an anode and a cathode, thereby improving the resistance of the steel to dew point corrosion of atmosphere and sulfuric acid. Since Cu is an element prone to segregation, the content of Cu is generally strictly controlled in the traditional process. In view of the rapid solidification effect of thin strip continuous casting, the upper limit of Cu is increased to 0.60% according to the present disclosure. In a certain sense, the increased Cu content can realize effective utilization of copper in steel scrap or inferior mineral resources (high-copper ore), promote the recycling of steel, reduce production cost, and achieve the purpose of sustainable development. The content of Cu designed according to the present disclosure is in the range of 0.20-0.60%.

Sn: Sn element is also one of the main participating elements in steel scrap. It is recognized as a harmful element in steel. Because Sn is an element prone to segregation, Sn even in a small amount may be enriched at the grain boundary, resulting in defects such as cracks. Therefore, the content of Sn element is strictly controlled in the traditional process. Because thin strip continuous casting has the characteristic of rapid solidification, interdendritic segregation of an element is greatly reduced. As a result, the solid solubility of the element can be increased greatly. Therefore, under the conditions of the thin strip continuous casting process, the content range of Sn element can be expanded, and the steelmaking cost can thus be reduced greatly. FIG. 2 shows the relationship between Sn element and average heat flux. It can be seen from FIG. 2 that when the amount of Sn added is less than 0.04%, there is little influence on the heat flux. That is, there is no influence on the solidification process of the thin strip. FIG. 3 shows the relationship between Sn content and surface roughness. Because cracks on the surface of a cast strip are usually generated at the uneven folds on the surface of the cast strip, surface roughness is used to characterize the occurrence of the surface cracks. If the roughness is large, the probability of cracking is high. It can be seen from FIG. 3 that the increase of the Sn content has no adverse influence on the surface quality of the cast strip under the condition of rapid solidification. As it can be seen from the results in FIGS. 2 and 3, Sn has no adverse influence on the solidification and surface quality of the cast strip. Therefore, according to the present disclosure, the limitation to the Sn content may be further relaxed, and the designed Sn content is in the range of 0.005-0.04%.

A manufacturing method for the high-strength, thin-gauge and high-corrosion-resistance steel according to the present disclosure comprises the following steps:

a) Smelting, wherein smelting is performed on the above chemical composition; wherein a basicity a=CaO/SiO₂ (mass ratio) for slagging in a steelmaking process is controlled at a<1.5, preferably a<1.2, or a=0.7-1.0; wherein a MnO/SiO₂ ratio (mass ratio) in molten steel for producing a low-melting-point MnO—SiO₂—Al₂O₃ ternary inclusion is controlled at 0.5-2, preferably 1-1.8; wherein a free oxygen content [O]_{Free} in the molten steel is 0.0005-0.005%; and wherein in the molten steel, Mn/S≥250;

b) Continuous casting, wherein twin-roll thin strip continuous casting is used for continuous casting, wherein a 1.5-3 mm thick cast strip is formed at the smallest gap between two crystallization rolls; wherein the crystallization rolls have a diameter of 500-1500 mm, preferably 800 mm; wherein water is supplied to an inside of the crystallization rolls for cooling; wherein a casting machine has a casting speed of 60-150 m/min; wherein a two-stage system for dispensing and distributing molten steel is used for molten steel delivery in the continuous casting, i.e., a tundish+a distributor;

c) Lower closed chamber protection, wherein after a continuously cast strip exits the crystallization rolls, the cast strip has a temperature of 1420-1480° C., and it enters a lower closed chamber directly, wherein a non-oxidizing gas is supplied to the lower closed chamber, wherein an oxygen concentration in the lower closed chamber is controlled at <5%; and wherein the cast strip has a temperature of 1150-1300° C. at an outlet of the lower closed chamber;

d) On-line hot rolling, wherein the cast strip is delivered through pinch rolls in the lower closed chamber to a rolling mill, and rolled into a rolled strip steel having a thickness of 0.8-2.5 mm at a rolling temperature of 1100-1250° C. and a hot rolling reduction rate controlled at 10-50%, preferably 30-50%, wherein the rolled strip steel has a thickness of 0.8-2.5 mm, preferably 1.0-1.8 mm;

e) Post-rolling cooling of the strip steel, wherein the rolled strip steel is cooled, wherein the strip steel is cooled by gas atomization cooling, wherein a cooling rate of the gas atomization cooling is 20-100° C./s; and

f) Coiling of the strip steel, wherein the hot-rolled strip steel is coiled directly into a coil after the cooling, wherein a coiling temperature is 500-600° C.

Further, the method also comprises step g): follow-up treatment, wherein the steel coil is pickled and flattened, and then used as a pickled-flattened coil, or the steel coil is pickled and galvanized, and then used as a galvanized plate.

Preferably, in step a), an electric furnace is used for smelting to produce molten steel, wherein 100% steel scrap may be selected as the raw material for smelting without pre-screening. Alternatively, a converter is used for smelting to produce molten steel, wherein steel scrap is added to the converter in an amount of 20% of the raw material for smelting without pre-screening. Then, the molten steel is delivered to an LF furnace, VD/VOD furnace or RH furnace for refining.

Preferably, in step c), the non-oxidizing gas is N₂, Ar, or CO₂ gas produced by sublimation of dry ice.

Preferably, in step e), the gas atomization cooling utilizes a gas-water ratio of 15:1-10:1, a gas pressure of 0.5-0.8 MPa, and a water pressure of 1.0-1.5 MPa. As used herein, the gas-water ratio refers to the flow ratio of compressed air to water, and the unit of the flow is m³/h.

Preferably, in step f), the coiling utilizes double-coiler coiling or Carrousel coiling.

Preferably, in step f), the hot-rolled and cooled strip steel is directly coiled into a coil after a poor-quality head portion of the strip steel is cut off with a head shear, and the coiling temperature is 500-600° C.

In the manufacturing method for the high-strength, thin-gauge, high-corrosion-resistance steel according to the present disclosure:

In order to improve the castability of the molten steel for thin strip continuous casting, the basicity a=CaO/SiO₂ (mass ratio) for slagging in the steelmaking process is controlled at a<1.5, preferably a<1.2, or a=0.7-1.0.

In order to improve the castability of the molten steel for thin strip continuous casting, it is necessary to obtain a low-melting-point MnO—SiO₂—Al₂O₃ ternary inclusion, as shown in the shaded area in FIG. 4. The MnO/SiO₂ (mass ratio) in the MnO—SiO₂-Al₂O₃ ternary inclusion is controlled at 0.5-2, preferably 1-1.8.

In order to improve the castability of the molten steel for thin strip continuous casting, oxygen (O) is an essential element to form an oxide inclusion in the steel. Since it's necessary to form the low-melting-point MnO—SiO₂—Al₂O₃ ternary inclusion according to the present disclosure, the free oxygen [O]_{Free} in the molten steel is required to be in the range of 0.0005-0.005%.

In order to improve the castability of the molten steel for thin strip continuous casting, among the above components, Mn and S must be controlled to satisfy the following relationship: Mn/S≥250.

Electric furnace steelmaking or converter steelmaking may be employed for the smelting to obtain molten steel. Then, the molten steel enters a necessary refining process, such as an LF furnace, a VD/VOD furnace, an RH furnace, etc.

The theoretical basis for precipitation of the BN phase in the cast strip occurring in the lower closing process:

The thermodynamic equations between boron and nitrogen, and between aluminum and nitrogen in γ-Fe in steel are as follows:

BN=B+N; Log[B][N]=−13970/T+5.24 (1)

AlN=Al+N; Log[A][N]=−6770/T+1.03 (2)

As shown by FIG. 5, the temperature at which BN begins to precipitate in the steel is around 1280° C., and the precipitation of BN levels off at 980° C., while the precipitation of AlN has just begun (the temperature at which AlN begins to precipitate is around 980° C.). The precipitation of BN precedes that of AlN thermodynamically. According to the present disclosure, the combination of B and N is completed in a lower enclosed chamber to generate coarse BN particles. This inhibits precipitation of fine AlN, and thus weakens the pinning effect of fine AlN on the grain boundary, so that the growth ability of grains is improved, and austenite grains are coarsened. As a result, the austenite grains are more uniform, which is beneficial to effectively reduce the yield ratio of the product and improve the properties of the product. In addition, the combination of B and N can effectively prevent appearance of the low-melting-point phase B₂O₃ at the grain boundary.

The rolled strip steel is cooled. Particularly, the strip steel is cooled by gas atomization cooling. The gas atomization cooling process can effectively reduce the thickness of the oxide scale on the strip steel surface, improve the temperature uniformity of the strip steel, and promote the surface quality of the strip steel. The gas atomization cooling utilizes a gas-water ratio of 15:1-10:1, a gas pressure of 0.5-0.8 MPa, and a water pressure of 1.0-1.5 MPa. After gas atomization, a high-pressure water mist is formed and sprayed on the surface of the steel strip. On the one hand, it plays a role in reducing the temperature of the steel strip. On the other hand, the water mist forms a dense gas film which covers the surface of the strip steel to protect the strip steel from oxidation, thereby effectively suppressing the growth of the oxide scale on the surface of the hot-rolled strip steel. With the use of this cooling process, the problems caused by traditional spraying or laminar cooling can be avoided, and the surface temperature of the strip steel can drop uniformly, so as to increase the temperature uniformity of the strip steel, and achieve the effect of homogenizing the internal microstructure. At the same time, the cooling is uniform, and the shape quality and performance stability of the strip steel can be improved. In addition, the thickness of the oxide scale on the surface of the strip steel can be reduced effectively. The cooling rate for the gas atomization cooling is in the range of 20-100° C./s.

In some embodiments according to the present disclosure, the use of a converter to provide molten steel for steelmaking requires that the manufacturer should have the conditions for providing molten iron. Generally, blast furnace ironmaking or non-blast furnace ironmaking equipment is needed. This belongs to the current long-process steel production mode. Nevertheless, since steel scrap resources are increasingly abundant nowadays, the government is advocating increasing the proportion of steel scrap supplied to converters, so as to achieve the purposes of saving energy, reducing consumption and reducing cost. The average level of steel scrap supplied to converters is about 8% in the past. Now and later, the targeted proportion of steel scrap supplied to converters is 15-25%. The proportion of steel scrap supplied to the converter according to the present disclosure can reach 20% or higher.

When an electric furnace is used to provide molten steel for steelmaking, steel scrap is used as the main raw material. In traditional processes such as die casting or thick slab continuous casting, the solidification cooling rate is only 10⁻¹−10° C./s. Grain boundary segregation of the residual elements in the steel scrap occurs during the solidification process, which deteriorates the properties and quality of the steel, and even causes direct cracking and fracturing in severe cases. Therefore, in the traditional process, these harmful elements must be strictly controlled. In the selection of steel scrap raw materials, pre-screening is required, and some special treatments are required in the steelmaking process, such as addition of a concentrate for dilution, etc., which undoubtedly increase the production cost. Due to the need to control the steel composition, there are certain quality requirements for the steel scrap raw materials to be used. Generally, the steel scrap needs to be pre-screened and classified. In order to enhance the production efficiency, some domestic electric furnace steel plants choose to add concentrates such as purchased sponge iron, iron carbide and the like to the raw material composition to dilute the harmful elements that are difficult to be removed from the steel scrap, and thus improve the quality of the molten steel. Some domestic steel plants that have both a blast furnace and an electric furnace add self-produced molten iron into the electric furnace as a raw material in the electric furnace to improve the production efficiency of the electric furnace, thereby shortening the tapping time of the electric furnace greatly. The blending ratio of the molten iron in the electric furnace can reach 30-50%.

The twin-roll thin strip continuous casting technology employed according to the present disclosure is a typical sub-rapid solidification process, wherein the solidification cooling rate is as high as 10²-10⁴° C./s. Some harmful residual elements in steel scrap, such as Cu, Sn, P, etc., can be solid dissolved into the steel matrix to the maximum extent without causing grain boundary segregation, so that the use of 100% steel scrap for smelting can be achieved without pre-screening, which reduces the raw material cost significantly. These residual elements can also play a role in solid solution strengthening, helping to produce ultra-thin hot-rolled strip steel having excellent properties. For these harmful residual elements in steel scrap, the comprehensive utilization of inferior steel scrap resources for production has the effects of “turning harm into profit” and “waste utilization”.

The coiling utilizes double-coiler coiling or Carrousel coiling to ensure continuous production of strip steel.

The main advantages of the present disclosure include:

The use of the thin strip continuous casting technology to produce high-strength and high-corrosion-resistance steel containing boron (B) has not been reported so far. The advantages are summarized as follows:

1. According to the present disclosure, complicated processes such as slab heating, multi-pass repeated hot rolling and the like are obviated. With the use of a twin-roll thin strip continuous casting+one-pass on-line hot rolling process, the production process is shorter, the efficiency is higher, and the investment cost for the production line and the production cost are reduced significantly.

2. According to the present disclosure, a good number of complicated intermediate steps in the traditional process for producing corrosion-resistant steel are obviated. Compared with the traditional production process, the energy consumption and the CO₂ emission in the production according to the present disclosure are reduced greatly, and environment-friendly products are obtained.

3. A thin strip continuous casting process is utilized to produce hot-rolled thin-gauge, corrosion-resistant steel according to the present disclosure. Because the Cr content is increased and the problem of Cr segregation does not exist, the corrosion resistance is improved greatly. Particularly, the corrosion resistance is doubled on the basis of the traditional corrosion-resistant steel, comparable to the corrosion resistance of stainless steel. At the same time, the thickness of the cast strip itself is relatively thin. The cast strip is hot rolled on-line to a desired product thickness, and the production of the thin-gauge product does not need cold rolling. The product is marketed directly for use. The purposes of supplying thin-gauge, hot-rolled plates and “replacing cold-rolled steel with hot-rolled steel” can be achieved, and the cost-effectiveness of the plates and strips can be improved significantly.

4. According to the present disclosure, with the addition of a trace amount of boron element to preferentially precipitate coarse BN particles in high-temperature austenite and inhibit precipitation of fine AlN, the pinning effect of fine AlN on the grain boundary is attenuated, and the growth ability of grains is promoted. As a result, the austenite grains are coarsened and homogenized. This is beneficial to improve the formability of the product.

5. According to the present disclosure, by using gas atomization cooling for the rolled strip steel, the problems caused by traditional spraying or laminar cooling can be avoided, and the surface temperature of the strip steel can drop uniformly, so as to increase the temperature uniformity of the strip steel, and achieve the effect of homogenizing the internal microstructure. At the same time, the cooling is uniform, and the shape quality and performance stability of the strip steel can be improved. In addition, the thickness of the oxide scale on the surface of the strip steel can be reduced effectively.

6. In the traditional process for cooling a slab, precipitation of alloy elements occurs, and re-dissolution of the alloy elements is insufficient when the slab is reheated, so that the utilization rate of the alloy elements is often reduced. In the thin strip continuous casting process according to the present disclosure, the high-temperature cast strip is hot rolled directly, and the added alloy elements mainly exist in a solid solution state. Thus, the utilization rate of the alloy elements can be increased.

7. According to the present disclosure, a Carrousel coiler is used for the hot-rolled steel strip to effectively shorten the length of the production line. At the same time, the in-situ coiling can greatly improve the control accuracy of the coiling temperature and improve the stability of the product properties.

8. The most significant features which distinguish the present disclosure from the existing thin strip continuous casting technology include the roll diameter of the crystallization rolls and the corresponding molten steel distribution mode. The technical feature of the EUROSTRIP technology is the crystallization rolls having a large diameter of Φ1500 mm. Due to the large crystallization rolls together with the large capacity of the molten pool, it's easy to distribute the molten steel, but the cost for manufacturing the crystallization rolls and the cost for operation and maintenance are high. The technical feature of the CASTRIP technology is the crystallization rolls having a small diameter of Φ500 mm Due to the small crystallization rolls together with the small capacity of the molten pool, it's very difficult to distribute the molten steel, but the cost for manufacturing the casting machine and the cost for operation and maintenance are low. In order to address the challenge of uniform distribution of molten steel in the small molten pool, CASTRIP adopts a three-stage system for dispensing and distributing molten steel (tundish+transition piece+distributor). The use of a three-stage distribution system for molten steel leads to a direct increase in the cost of refractory materials. More importantly, the three-stage distribution system for molten steel extends the flow path of the molten steel, and the temperature drop of the molten steel is also larger. In order to achieve the required temperature of the molten steel in the molten pool, the tapping temperature needs to be increased greatly. The increased tapping temperature will lead to problems such as increased steelmaking cost, increased energy consumption and shortened life of refractory materials.

9. The crystallization rolls according to the present disclosure have a diameter of 500-1500 mm, with crystallization rolls having a roll diameter of Φ800 mm being preferred. A two-stage system for dispensing and distributing molten steel (tundish+distributor) is adopted. The molten steel flowing out of the distributor forms different distribution patterns along the roll surfaces and the two side surfaces, and flows in two paths without interfering with each other. Due to the use of a two-stage distribution system, in contrast to a three-stage distribution system, the cost of refractory materials is reduced greatly; and the flow path of the molten steel is shortened, so that the temperature drop of the molten steel is reduced, and the tapping temperature can be lowered. Compared with the three-stage distribution system, the tapping temperature can be lowered by 30-50° C. The decreased tapping temperature can effectively reduce the cost of steelmaking, save energy and prolong the life of refractory materials. The combined use of crystallization rolls having a preferred roll diameter of D800 mm and a two-stage system for dispensing and distributing molten steel according to the present disclosure not only meets the requirement of stable distribution of molten steel, but also achieves the goals of simple structure, convenient operation and low processing cost.

### DESCRIPTION OF THE DRAWINGS

FIG. 1 is a schematic view showing the process layout of a twin-roll thin strip continuous casting process;

FIG. 2 is a schematic diagram showing the relationship between Sn content and average heat flux;

FIG. 3 is a schematic diagram showing the relationship between Sn content and cast strip surface roughness;

FIG. 4 is a ternary phase diagram of MnO—SiO₂—Al₂O₃ (shaded area: low melting point area);

FIG. 5 is a schematic diagram showing thermodynamic precipitation curves of BN and AlN.

### DETAILED DESCRIPTION

The present disclosure will be further described with reference to the following examples and accompanying drawings, but these examples by no means limit the present disclosure. Any changes made by those skilled in the art in the implementation of the present disclosure under the inspiration of the present specification will fall within the protection scope of the claims in the present disclosure.

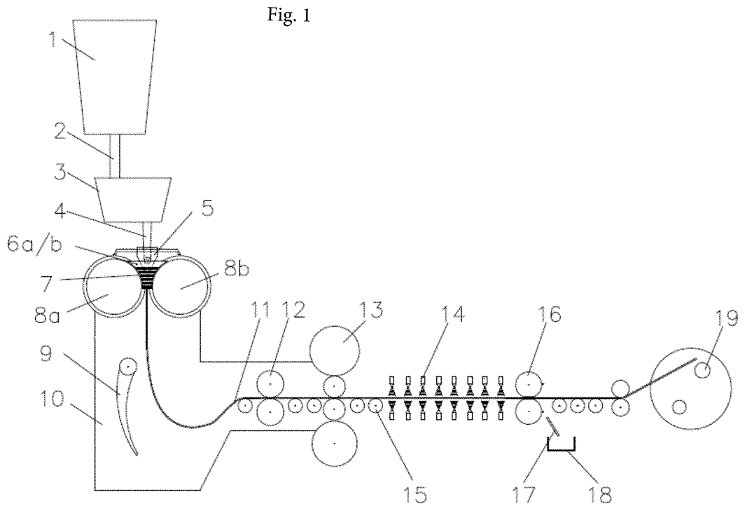

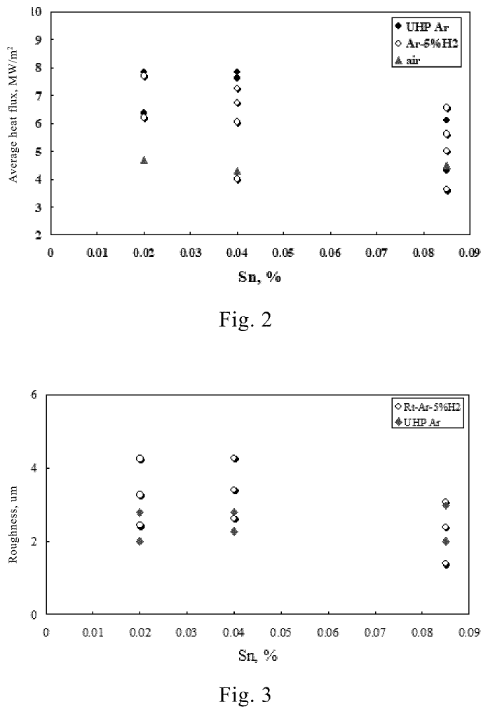

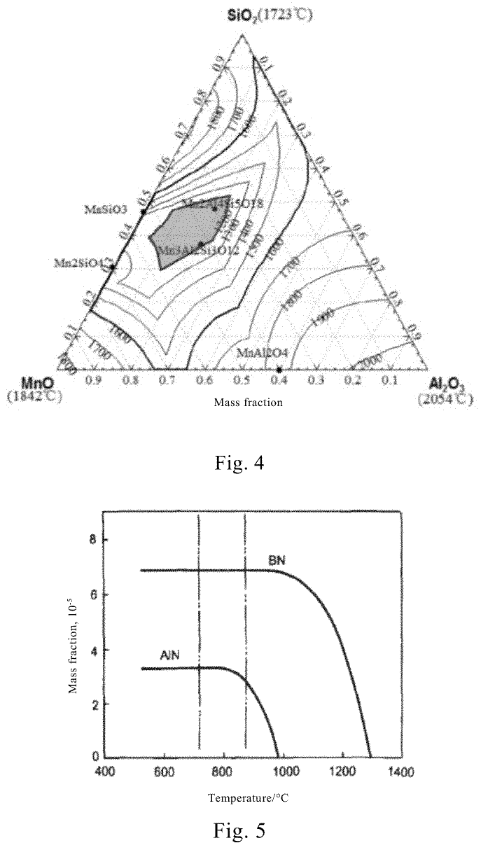

Referring to FIG. 1, the molten steel that conforms to the chemical composition designed according to the present disclosure passes through a ladle 1, a ladle shroud 2, a tundish 3, a submerged nozzle 4 and a distributor 5, and is then directly poured into a molten pool 7 formed with side sealing plate devices 6a, 6b and two counter-rotating crystallization rolls 8a, 8b capable of rapid cooling. The molten steel solidifies on the circumferential surfaces of the rotating crystallization rolls 8a, 8b to form a solidified shell which gradually grows, and then forms a 1.5-3 mm thick cast strip 11 at the minimum gap (nip point) between the two crystallization rolls. The diameter of the crystallization rolls according to the present disclosure is between 500-1500 mm, and water is supplied to the inside of the crystallization rolls for cooling. Depending on the thickness of the cast strip, the casting speed of the casting machine is in the range of 60-150 m/min.

After the cast strip 11 exits the crystallization rolls 8a and 8b, the temperature of the cast strip is 1420-1480° C., and the cast strip enters a lower closed chamber 10 directly. The lower closed chamber 10 is supplied with an inert gas to protect the strip steel, i.e. protecting the strip steel from oxidation. The anti-oxidation protective atmosphere may be N₂, or Ar, or other non-oxidizing gas, such as CO₂ gas obtained by sublimation of dry ice. The oxygen concentration in the lower closed chamber 10 is controlled to be <5%. The anti-oxidation protection provided by the lower closed chamber 10 to the cast strip 11 extends to the inlet of the rolling mill 13. The temperature of the cast strip at the outlet of the lower closed chamber 10 is 1150-1300° C. Then, the cast strip is delivered to the hot rolling mill 13 through a swinging guide plate 9, pinch rolls 12 and a roll table 15. After hot rolling, a hot rolled strip of 0.8-2.5 mm in thickness is formed. The rolled strip steel is cooled by gas atomization cooling with the use of a gas atomization rapid cooling device 14 to improve the temperature uniformity of the strip steel. After the head portion of the strip steel is cut off by a flying shear 16, the cut head portion falls into a flying shear pit 18 along a flying shear guide plate 17, and the hot-rolled strip with the head portion cut off enters a coiler 19 for coiling. After the steel coil is taken off the coiler, it is cooled in air to room temperature. Finally, the steel coil produced may be used after pickling-flattening, or after pickling-hot-dip galvanization.

The chemical compositions of Examples 1-14 according to the present disclosure using steel scrap as a raw material are shown in Table 2, and the balance is Fe and other unavoidable impurities. The process parameters of the manufacturing method according to the present disclosure are shown in Table 3, and the mechanical properties of the hot-rolled strips obtained finally are shown in Table 4.

Corrosion resistance testing on the steel of the Examples: 72 h periodic infiltration and cyclic corrosion experiments were carried out according to Test Method for Periodic Infiltration and Corrosion of Corrosion Resistant Steel (TB/T2375-93), using ordinary carbon steel Q345B and traditional atmospheric corrosion resistant steel SPA-H as comparative samples. The average corrosion rate was obtained by calculating the corrosion weight loss per unit area of a sample, and then the relative corrosion rate of the steel was obtained. The test results are shown in Table 5.

To sum up, the high-strength and high-corrosion-resistance steel manufactured with the designed steel composition using the thin strip continuous casting process according to the present disclosure has a yield strength of ≥480 MPa, a tensile strength of ≥600 MPa, an elongation of ≥22%, and a yield ratio of less than 0.8, and the cold bendability is qualified. The comparison results of corrosion resistance also show that the relative corrosion rate of the steel according to the present disclosure is ≤25%, and the average corrosion rate is ≤0.1250 mg/cm²·h.

TABLE 2
Chemical compositions of the steel Examples (wt. %)

| Ex. No. | C | Si | Mn | P | S | N | O | Als | Cr | Ni | Nb | V | Cu | Sn | B |
|---|---|---|---|---|---|---|---|---|---|---|---|---|---|---|---|
| Ex. 1 | 0.036 | 0.27 | 1.36 | 0.005 | 0.005 | 0.0077 | 0.0093 | 0.0009 | 4.8 | 1.8 | 0.01 | 0.05 | 0.38 | | 0.003 |
| Ex. 2 | 0.026 | 0.10 | 0.90 | 0.015 | 0.003 | 0.0063 | 0.0110 | 0.0006 | 5.1 | 2.3 | 0.03 | | 0.25 | 0.005 | 0.001 |
| Ex. 3 | 0.048 | 0.39 | 1.27 | 0.013 | 0.004 | 0.0059 | 0.0150 | 0.0004 | 5.0 | 3.0 | 0.04 | | 0.10 | 0.033 | 0.004 |
| Ex. 4 | 0.020 | 0.26 | 1.11 | 0.017 | 0.004 | 0.0088 | 0.0130 | 0.0008 | 4.2 | 2.7 | | 0.03 | | 0.040 | 0.006 |
| Ex. 5 | 0.025 | 0.43 | 0.66 | 0.009 | 0.002 | 0.0053 | 0.0120 | 0.0007 | 4.1 | 1.3 | 0.05 | | 0.44 | 0.014 | 0.003 |
| Ex. 6 | 0.047 | 0.47 | 0.65 | 0.014 | 0.002 | 0.0047 | 0.0070 | 0.0008 | 5.8 | 1.0 | | 0.08 | 0.53 | | 0.005 |
| Ex. 7 | 0.045 | 0.17 | 0.85 | 0.017 | 0.003 | 0.0040 | 0.0100 | 0.0005 | 6.0 | 1.8 | 0.06 | | 0.17 | 0.035 | 0.003 |
| Ex. 8 | 0.048 | 0.37 | 1.00 | 0.016 | 0.004 | 0.0100 | 0.0085 | 0.0006 | 4.4 | 1.4 | | 0.04 | 0.60 | 0.015 | 0.002 |
| Ex. 9 | 0.038 | 0.35 | 0.84 | 0.018 | 0.003 | 0.0088 | 0.0200 | 0.0003 | 5.7 | 2.5 | 0.05 | | | 0.027 | 0.004 |
| Ex. 10 | 0.060 | 0.46 | 0.40 | 0.020 | 0.001 | 0.0065 | 0.0125 | 0.0004 | 5.3 | 2.2 | 0.04 | 0.05 | 0.52 | 0.016 | 0.006 |
| Ex. 11 | 0.053 | 0.50 | 0.64 | 0.010 | 0.002 | 0.0090 | 0.0090 | 0.0005 | 4.5 | 2.7 | 0.03 | | 0.48 | | 0.003 |
| Ex. 12 | 0.043 | 0.25 | 1.70 | 0.014 | 0.0067 | 0.0075 | 0.0118 | 0.0003 | 5.8 | 1.7 | 0.08 | 0.02 | 0.35 | 0.012 | 0.002 |
| Ex. 13 | 0.045 | 0.38 | 1.37 | 0.009 | 0.004 | 0.0055 | 0.0132 | 0.0006 | 4.6 | 2.9 | | 0.06 | | 0.038 | 0.005 |
| Ex. 14 | 0.035 | 0.33 | 1.40 | 0.008 | 0.003 | 0.0044 | 0.0075 | 0.0005 | 5.3 | 1.8 | 0.04 | 0.07 | 0.27 | 0.027 | 0.004 |

TABLE 3
Process parameters of the Examples

| | | | Oxygen | | | | | |
|---|---|---|---|---|---|---|---|---|
| | | Atmosphere | concentration | | Hot | Hot-rolled | | |
| | Cast strip | in lower | in lower | Hot rolling | rolling | strip | Post-rolling | Coiling |
| | thickness | closed | closed | temperature | reduction | thickness | cooling rate | temperature |
| | mm | chamber | chamber % | ° C. | rate/% | mm | ° C./s | ° C. |
| Ex. 1 | 2.1 | N₂ | 3.5 | 1180 | 30 | 1.48 | 75 | 595 |
| Ex. 2 | 2.4 | Ar | 4.2 | 1220 | 43 | 1.36 | 70 | 600 |
| Ex. 3 | 2.0 | N₂ | 2.5 | 1200 | 33 | 1.35 | 59 | 560 |
| Ex. 4 | 1.9 | CO₂ | 2.7 | 1150 | 34 | 1.25 | 20 | 560 |
| Ex. 5 | 1.5 | Ar | 3.5 | 1185 | 33 | 1.0 | 92 | 570 |
| Ex. 6 | 2.6 | Ar | 2.8 | 1100 | 29 | 1.85 | 72 | 550 |
| Ex. 7 | 2.5 | N₂ | 1.5 | 1190 | 30 | 1.75 | 65 | 500 |
| Ex. 8 | 1.7 | CO₂ | 0.8 | 1220 | 26 | 1.25 | 40 | 580 |
| Ex. 9 | 1.6 | N₂ | 1.5 | 1250 | 38 | 1.0 | 22 | 550 |
| Ex. 10 | 2.0 | N₂ | 1.9 | 1170 | 30 | 1.4 | 75 | 560 |
| Ex. 11 | 2.5 | Ar | 1.8 | 1240 | 28 | 1.8 | 100 | 585 |
| Ex. 12 | 2.3 | N₂ | 2.6 | 1170 | 46 | 1.25 | 60 | 575 |
| Ex. 13 | 2.0 | CO₂ | 2.4 | 1180 | 50 | 1.0 | 30 | 580 |
| Ex. 14 | 1.6 | Ar | 2.5 | 1160 | 31 | 1.1 | 25 | 560 |

TABLE 4
Mechanical properties of the steel products in the Examples

| | | Final | | | | | 180° bend |
|---|---|---|---|---|---|---|---|
| | Cast strip | product | Yield | Tensile | | | ddiameter of curve |
| | thickness | thickness | strength | strength | Elongation | Yield | center a = strip |
| Ex. No. | mm | mm | MPa | MPa | % | ratio | thickness |
| Ex. 1 | 2.1 | 1.48 | 483 | 627 | 23 | 0.77 | Pass |
| Ex. 2 | 2.4 | 1.36 | 503 | 662 | 29 | 0.76 | Pass |
| Ex. 3 | 2.0 | 1.35 | 482 | 628 | 25 | 0.77 | Pass |
| Ex. 4 | 1.9 | 1.25 | 494 | 665 | 23 | 0.74 | Pass |
| Ex. 5 | 1.5 | 1.0 | 503 | 639 | 29 | 0.79 | Pass |
| Ex. 6 | 2.6 | 1.85 | 489 | 642 | 24 | 0.76 | Pass |
| Ex. 7 | 2.5 | 1.75 | 480 | 638 | 30 | 0.75 | Pass |
| Ex. 8 | 1.7 | 1.25 | 488 | 638 | 28 | 0.76 | Pass |
| Ex. 9 | 1.6 | 1.0 | 515 | 673 | 28 | 0.77 | Pass |
| Ex. 10 | 2.0 | 1.4 | 510 | 658 | 27 | 0.78 | Pass |
| Ex. 11 | 2.5 | 1.8 | 491 | 628 | 24 | 0.78 | Pass |
| Ex. 12 | 2.3 | 1.25 | 501 | 650 | 26 | 0.77 | Pass |
| Ex. 13 | 2.0 | 1.0 | 491 | 633 | 24 | 0.78 | Pass |
| Ex. 14 | 1.6 | 1.1 | 520 | 677 | 27 | 0.77 | Pass |

TABLE 5
Test results of the atmospheric corrosion
resistance of the steel Examples

| | Average corrosion | Relative corrosion |
|---|---|---|
| | rate, mg/cm² · h | rate, % |
| Q345B | 0.4902 | 100 |
| SPA-H | 0.2148 | 43.82 |
| Ex. 1 | 0.1157 | 23.60 |
| Ex. 2 | 0.1202 | 24.52 |
| Ex. 3 | 0.1164 | 23.75 |
| Ex. 4 | 0.1173 | 23.93 |
| Ex. 5 | 0.1185 | 24.17 |
| Ex. 6 | 0.1108 | 22.60 |
| Ex. 7 | 0.1216 | 24.81 |
| Ex. 8 | 0.1218 | 24.85 |
| Ex. 9 | 0.1137 | 23.19 |
| Ex. 10 | 0.1221 | 24.91 |
| Ex. 11 | 0.1182 | 24.11 |
| Ex. 12 | 0.1158 | 23.62 |
| Ex. 13 | 0.1187 | 24.21 |
| Ex. 14 | 0.1206 | 24.60 |

The chemical compositions of Examples 15-28 according to the present disclosure without using steel scrap as a raw material are shown in Table 6, and the balance is Fe and other unavoidable impurities. The process parameters of the manufacturing method according to the present disclosure are shown in Table 7, and the mechanical properties of the hot-rolled strips obtained finally are shown in Table 8.

Corrosion resistance testing on the steel of the Examples: 72 h periodic infiltration and cyclic corrosion experiments were carried out according to Test Method for Periodic Infiltration and Corrosion of Corrosion Resistant Steel (TB/T2375-93), using ordinary carbon steel Q345B and traditional atmospheric corrosion resistant steel SPA-H as comparative samples. The average corrosion rate was obtained by calculating the corrosion weight loss per unit area of a sample, and then the relative corrosion rate of the steel was obtained. The test results are shown in Table 9.

To sum up, the high-strength and high-corrosion-resistance steel manufactured with the designed steel composition using the thin strip continuous casting process according to the present disclosure has a yield strength of ≥480 MPa, a tensile strength of ≥600 MPa, an elongation of ≥22%, and a yield ratio of less than 0.8, and the cold bendability is qualified. The comparison results of corrosion resistance also show that the relative corrosion rate of the steel according to the present disclosure is ≤25%, and the average corrosion rate is ≤0.1250 mg/cm²·h.

TABLE 6
Chemical compositions of the steel Examples (wt. %)

| | C | Si | Mn | P | S | N | O | Als | Cr | Ni | Nb | V | B |
|---|---|---|---|---|---|---|---|---|---|---|---|---|---|
| Ex. 15 | 0.036 | 0.23 | 1.35 | 0.008 | 0.005 | 0.0074 | 0.0093 | 0.0009 | 4.8 | 1.9 | 0.01 | 0.05 | 0.003 |
| Ex. 16 | 0.044 | 0.10 | 0.90 | 0.013 | 0.003 | 0.0061 | 0.0110 | 0.0006 | 5.1 | 2.5 | 0.02 | | 0.001 |
| Ex. 17 | 0.048 | 0.28 | 1.28 | 0.015 | 0.004 | 0.0058 | 0.0150 | 0.0004 | 5.3 | 3.0 | 0.05 | | 0.004 |
| Ex. 18 | 0.020 | 0.36 | 1.10 | 0.013 | 0.004 | 0.0087 | 0.0130 | 0.0008 | 4.5 | 2.5 | | 0.03 | 0.006 |
| Ex. 19 | 0.028 | 0.45 | 0.65 | 0.009 | 0.002 | 0.0052 | 0.0120 | 0.0007 | 4.1 | 2.9 | 0.04 | | 0.003 |
| Ex. 20 | 0.038 | 0.46 | 0.67 | 0.012 | 0.002 | 0.0046 | 0.0070 | 0.0008 | 5.3 | 1.0 | | 0.08 | 0.005 |
| Ex. 21 | 0.044 | 0.17 | 0.85 | 0.015 | 0.003 | 0.0040 | 0.0100 | 0.0005 | 6.0 | 1.3 | 0.06 | | 0.003 |
| Ex. 22 | 0.042 | 0.38 | 1.00 | 0.014 | 0.004 | 0.0100 | 0.0085 | 0.0006 | 4.4 | 1.4 | | 0.04 | 0.002 |
| Ex. 23 | 0.026 | 0.36 | 0.84 | 0.018 | 0.003 | 0.0078 | 0.0200 | 0.0003 | 5.3 | 2.5 | 0.04 | | 0.004 |
| Ex. 24 | 0.060 | 0.48 | 0.40 | 0.020 | 0.001 | 0.0055 | 0.0125 | 0.0004 | 5.5 | 2.3 | 0.05 | 0.05 | 0.006 |
| Ex. 25 | 0.047 | 0.50 | 0.65 | 0.010 | 0.002 | 0.0090 | 0.0090 | 0.0005 | 4.5 | 2.8 | 0.04 | | 0.003 |
| Ex. 26 | 0.053 | 0.37 | 1.70 | 0.012 | 0.0067 | 0.0085 | 0.0118 | 0.0003 | 5.8 | 1.6 | 0.08 | 0.02 | 0.002 |
| Ex. 27 | 0.049 | 0.44 | 1.37 | 0.008 | 0.004 | 0.0045 | 0.0132 | 0.0006 | 4.7 | 2.9 | | 0.06 | 0.005 |
| Ex. 28 | 0.025 | 0.28 | 1.40 | 0.017 | 0.003 | 0.0064 | 0.0075 | 0.0005 | 5.6 | 1.7 | 0.04 | 0.07 | 0.004 |

TABLE 7
Process parameters of the Examples

| | | | Oxygen | | | | | |
|---|---|---|---|---|---|---|---|---|
| | | Atmosphere | concentration | | | Hot-rolled | | |
| | Cast strip | in lower | in lower | Hot rolling | Hot rolling | strip | Post-rolling | Coiling |
| | thickness | closed | closed | temperature | reduction | thickness, | cooling rate, | temperature |
| | mm | chamber | chamber % | ° C. | rate/% | mm | ° C./s | ° C. |
| Ex. 15 | 2.2 | N₂ | 3.5 | 1180 | 34 | 1.45 | 85 | 595 |
| Ex. 16 | 2.5 | Ar | 4.2 | 1220 | 46 | 1.35 | 30 | 600 |
| Ex. 17 | 2.1 | N₂ | 2.5 | 1200 | 38 | 1.3 | 79 | 560 |
| Ex. 18 | 1.8 | CO₂ | 2.7 | 1150 | 31 | 1.25 | 20 | 560 |
| Ex. 19 | 1.6 | Ar | 3.5 | 1185 | 38 | 1.0 | 92 | 570 |
| Ex. 20 | 2.7 | Ar | 2.8 | 1100 | 31 | 1.85 | 72 | 550 |
| Ex. 21 | 1.9 | N₂ | 1.5 | 1190 | 34 | 1.25 | 65 | 500 |
| Ex. 22 | 1.5 | CO₂ | 0.8 | 1220 | 30 | 1.05 | 50 | 580 |
| Ex. 23 | 1.7 | N₂ | 1.5 | 1250 | 41 | 1.0 | 22 | 550 |
| Ex. 24 | 2.0 | N₂ | 1.9 | 1170 | 30 | 1.4 | 75 | 560 |
| Ex. 25 | 2.5 | Ar | 1.8 | 1240 | 40 | 1.5 | 100 | 585 |
| Ex. 26 | 2.2 | N₂ | 2.6 | 1170 | 43 | 1.25 | 60 | 575 |
| Ex. 27 | 2.0 | CO₂ | 2.4 | 1180 | 50 | 1.0 | 30 | 580 |
| Ex. 28 | 1.6 | Ar | 2.5 | 1160 | 31 | 1.1 | 25 | 560 |

TABLE 8
Mechanical properties of the steel products in the Examples

| | | | | | | | 180° bend |
|---|---|---|---|---|---|---|---|
| | Cast strip | | Yield | Tensile | | | diameter of curve |
| | thickness, | Final product | strength | strength | Elongation | Yield | center a = strip |
| | mm | thickness mm | MPa | MPa | % | ratio | thickness |
| Ex. 15 | 2.2 | 1.45 | 492 | 625 | 26 | 0.79 | Pass |
| Ex. 16 | 2.5 | 1.35 | 513 | 660 | 24 | 0.78 | Pass |
| Ex. 17 | 2.1 | 1.3 | 482 | 622 | 26 | 0.77 | Pass |
| Ex. 18 | 1.8 | 1.25 | 494 | 655 | 27 | 0.75 | Pass |
| Ex. 19 | 1.6 | 1.0 | 500 | 638 | 28 | 0.78 | Pass |
| Ex. 20 | 2.7 | 1.85 | 489 | 642 | 23 | 0.76 | Pass |
| Ex. 21 | 1.9 | 1.25 | 484 | 635 | 26 | 0.76 | Pass |
| Ex. 22 | 1.5 | 1.05 | 485 | 638 | 28 | 0.76 | Pass |
| Ex. 23 | 1.7 | 1.0 | 525 | 673 | 27 | 0.78 | Pass |
| Ex. 24 | 2.0 | 1.4 | 514 | 658 | 24 | 0.78 | Pass |
| Ex. 25 | 2.5 | 1.5 | 496 | 624 | 23 | 0.79 | Pass |
| Ex. 26 | 2.2 | 1.25 | 506 | 650 | 29 | 0.78 | Pass |
| Ex. 27 | 2.0 | 1.0 | 498 | 636 | 25 | 0.78 | Pass |
| Ex. 28 | 1.6 | 1.1 | 526 | 667 | 26 | 0.79 | Pass |

TABLE 9
Test results of the atmospheric corrosion
resistance of the steel Examples

| | Average corrosion | Relative corrosion |
|---|---|---|
| | rate, mg/cm² · h | rate, % |
| Q345B | 0.4902 | 100 |
| SPA-H | 0.2148 | 43.82 |
| Ex. 15 | 0.1187 | 24.21 |
| Ex. 16 | 0.1218 | 24.85 |
| Ex. 17 | 0.1148 | 23.42 |
| Ex. 18 | 0.1186 | 24.19 |
| Ex. 19 | 0.1163 | 23.73 |
| Ex. 20 | 0.1028 | 20.97 |
| Ex. 21 | 0.1176 | 23.99 |
| Ex. 22 | 0.1224 | 24.97 |
| Ex. 23 | 0.1109 | 22.62 |
| Ex. 24 | 0.1139 | 23.24 |
| Ex. 25 | 0.1185 | 24.17 |
| Ex. 26 | 0.1108 | 22.60 |
| Ex. 27 | 0.1156 | 23.58 |
| Ex. 28 | 0.1203 | 24.54 |

1. A high-strength, thin-gauge and high-corrosion-resistance steel, comprising the following chemical elements in weight percentages: C: 0.02-0.06%, Si: 0.1-0.5%, Mn: 0.4-1.7%, P≤=0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, meeting the following conditions:
Comprising one or both of Nb: 0.01-0.08% and V: 0.01-0.08%; and/or one or both of Cu: 0.1-0.6% and Sn: 0.005-0.05%;
Mn/S≥250.

2. The high-strength, thin-gauge and high-corrosion-resistance steel according to claim 1, wherein the high-strength, thin-gauge and high-corrosion-resistance steel comprises the following chemical elements in weight percentages: C: 0.02-0.06%, Si: 0.1-0.5%, Mn: 0.4-1.7%, P≤=0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, meets the following conditions: it comprises one or both of Nb: 0.01-0.08% and V: 0.01-0.08%; and Mn/S≥250.

3. The high-strength, thin-gauge and high-corrosion-resistance steel according to claim 1, wherein the high-strength, thin-gauge and high-corrosion-resistance steel comprises the following chemical elements in weight percentages: C: 0.02-0.06%, Si: 0.1-0.5%, Mn: 0.4-1.7%, P≤=0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, meets the following conditions: it comprises one or both of Nb: 0.01-0.08% and V: 0.01-0.08% and one or both of Cu: 0.1-0.6% and Sn: 0.005-0.05%; and Mn/S≥250.

4. The high-strength, thin-gauge, and high-corrosion-resistance steel according to claim 1, wherein the high-strength, thin-gauge, and high-corrosion-resistance steel has a microstructure of bainite, or acicular ferrite, or a mixed microstructure of bainite+acicular ferrite.

5. The high-strength, thin-gauge, and high-corrosion-resistance steel according to claim 1, wherein the high-strength, thin-gauge, and high-corrosion-resistance steel has a yield strength of ≥480 MPa, a tensile strength of ≥600 MPa, an elongation of ≥22%, and a relative corrosion rate of ≤25%.

6. The high-strength, thin-gauge, and high-corrosion-resistance steel according to claim 1, wherein the high-strength, thin-gauge, and high-corrosion-resistance steel has a thickness of 0.8-2.5 mm.

7. The high-strength, thin-gauge, and high-corrosion-resistance steel according to claim 1, wherein the high-strength, thin-gauge, and high-corrosion-resistance steel has an average corrosion rate of <0.1250 mg/cm²·h.

8. The high-strength, thin-gauge, and high-corrosion-resistance steel according to claim 1, wherein the high-strength, thin-gauge, and high-corrosion-resistance steel has a yield ratio of less than 0.8.

9. A manufacturing method for the high-strength, thin-gauge, and high-corrosion-resistance steel according to claim 1, comprising the following steps:
a) Smelting;
wherein smelting is performed on the chemical composition defined in claim 1; wherein a basicity a=CaO/SiO₂ (mass ratio) for slagging in a steelmaking process is controlled at a<1.5, wherein a MnO/SiO₂ ratio (mass ratio) in molten steel for producing a low-melting-point MnO—SiO₂—Al₂O₃ ternary inclusion is controlled at 0.5-2, wherein a free oxygen content [O]_{Free} in the molten steel is 0.0005-0.005%; and wherein in the molten steel, Mn/S≥250;
b) Continuous casting
wherein twin-roll thin strip continuous casting is used for the continuous casting, wherein a 1.5-3 mm thick cast strip is formed at the smallest gap between two crystallization rolls; wherein the crystallization rolls have a diameter of 500-1500 mm, wherein water is supplied to an inside of the crystallization rolls for cooling; wherein a casting machine has a casting speed of 60-150 m/min; wherein a two-stage system for dispensing and distributing molten steel is used for molten steel delivery in the continuous casting, i.e., a tundish+a distributor;
c) Lower closed chamber protection
wherein after a continuously cast strip exits the crystallization rolls, the cast strip has a temperature of 1420-1480° C., and it enters a lower closed chamber directly, wherein a non-oxidizing gas is supplied to the lower closed chamber, wherein an oxygen concentration in the lower closed chamber is controlled at <5%; and wherein the cast strip has a temperature of 1150-1300° C. at an outlet of the lower closed chamber;
d) On-line hot rolling
wherein the cast strip is delivered through pinch rolls in the lower closed chamber to a rolling mill, and rolled into a rolled strip steel having a thickness of 0.8-2.5 mm at a rolling temperature of 1100-1250° C. and a hot rolling reduction rate controlled at 10-50%, wherein the rolled strip steel has a thickness of 0.8-2.5 mm;
e) Post-rolling cooling of the strip steel
wherein the rolled strip steel is cooled, wherein the strip steel is cooled by gas atomization cooling, wherein a cooling rate of the gas atomization cooling is 20-100° C./s; and
f) Coiling of the strip steel
wherein the hot-rolled strip steel is coiled directly into a coil after the cooling, wherein a coiling temperature is 500-600° C.

10. The manufacturing method for the high-strength, thin-gauge, and high-corrosion-resistance steel according to claim 9, further comprising step g): follow-up treatment, wherein the steel coil is pickled and flattened, and then used as a pickled-flattened coil, or the steel coil is pickled and galvanized, and then used as a galvanized plate.

11. The manufacturing method for the high-strength, thin-gauge, and high-corrosion-resistance steel according to claim 9, wherein in step c), the non-oxidizing gas is N₂, Ar, or CO₂ gas produced by sublimation of dry ice.

12. The manufacturing method for the high-strength, thin-gauge, and high-corrosion-resistance steel according to claim 9, wherein in step e), the gas atomization cooling utilizes a gas-water flow ratio of 15:1-10:1, a gas pressure of 0.5-0.8 MPa, and a water pressure of 1.0-1.5 MPa, wherein the flow has a unit of m³/h.

13. The manufacturing method for the high-strength, thin-gauge, and high-corrosion-resistance steel according to claim 9, wherein in step f), the coiling utilizes double-coiler coiling or Carrousel coiling.

14. The manufacturing method for the high-strength, thin-gauge, and high-corrosion-resistance steel according to claim 9, wherein in step f), the hot-rolled and cooled strip steel is directly coiled into a coil after a poor-quality head portion of the strip steel is cut off with a head shear, and the coiling temperature is 500-600° C.

15. The manufacturing method for the high-strength, thin-gauge, and high-corrosion-resistance steel according to claim 9, wherein in step a), an electric furnace is used for smelting to produce molten steel, wherein 100% steel scrap is selected as a raw material for smelting without pre-screening; or a converter is used for smelting to produce molten steel, wherein steel scrap is added to the converter in an amount of 20% of a raw material for smelting without pre-screening; wherein the molten steel is then delivered to an LF furnace, VD/VOD furnace or RH furnace for refining.

16. The high-strength, thin-gauge, and high-corrosion-resistance steel according to claim 6, wherein the high-strength, thin-gauge, and high-corrosion-resistance steel has a thickness of 1.0-1.8 mm.

17. The manufacturing method for the high-strength, thin-gauge, and high-corrosion-resistance steel according to claim 9, wherein the basicity a is controlled at a<1.2, or a=0.7-1.0; the MnO/SiO₂ ratio is controlled at 1-1.8; and/or the crystallization rolls have a diameter of 800 mm; the hot rolling reduction rate is controlled at 30-50%; and/or wherein the rolled strip steel has a thickness of 1.0-1.8 mm.

18. The manufacturing method for the high-strength, thin-gauge, and high-corrosion-resistance steel according to claim 9, wherein the high-strength, thin-gauge and high-corrosion-resistance steel comprises the following chemical elements in weight percentages: C: 0.02-0.06%, Si: 0.1-0.5%, Mn: 0.4-1.7%, P≤=0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, meets the following conditions: it comprises one or both of Nb: 0.01-0.08% and V: 0.01-0.08%; and Mn/S≥250.

19. The manufacturing method for the high-strength, thin-gauge, and high-corrosion-resistance steel according to claim 9, wherein the high-strength, thin-gauge and high-corrosion-resistance steel comprises the following chemical elements in weight percentages: C: 0.02-0.06%, Si: 0.1-0.5%, Mn: 0.4-1.7%, P≤=0.02%, Cr: 4.0-6.0%, Ni: 1.0-3.0%, S≤0.007%, N: 0.004-0.010%, Als<0.001%, B: 0.001-0.006%, total oxygen [O]_{T}: 0.007-0.020%, and a balance of Fe and unavoidable impurities, and, at the same time, meets the following conditions: it comprises one or both of Nb: 0.01-0.08% and V: 0.01-0.08% and one or both of Cu: 0.1-0.6% and Sn: 0.005-0.05%; and Mn/S≥250.

20. The manufacturing method for the high-strength, thin-gauge, and high-corrosion-resistance steel according to claim 9, wherein the high-strength, thin-gauge, and high-corrosion-resistance steel has a microstructure of bainite, or acicular ferrite, or a mixed microstructure of bainite+acicular ferrite, and/or the high-strength, thin-gauge, and high-corrosion-resistance steel has a yield strength of ≥480 MPa, a tensile strength of ≥600 MPa, an elongation of ≥22%, and a relative corrosion rate of ≤25%.
